(19) United States
(12) Patent Application Publication
(10) Pub. No.: US 2022/0286998 A1
(43) Pub. Date: Sep. 8, 2022

(54) NETWORK-ASSISTED INTER-DRONE POSITIONING

(71) Applicant: Telefonaktiebolaget LM Ericsson (publ), Stockholm (SE)

(72) Inventors: Satyam DWIVEDI, Solna (SE); Sara MODARRES RAZAVI, Linköping (SE); Xingqin LIN, San Jose, CA (US); Fredrik GUNNARSSON, Linköping (SE)

(21) Appl. No.: 17/637,556

(22) PCT Filed: Aug. 27, 2019
(86) PCT No.: PCT/SE2019/050799

§ 371 Date: Feb. 23, 2022

(51) Int. Cl. H04W 64/00

(52) U.S. Cl. CPC H04W 64/00

(57) ABSTRACT

Embodiments of a method performed by a network node for determining a position of a mobile node are disclosed herein. In some embodiments, the method performed by a network node for determining a position of a mobile node includes generating a location transmission schedule for a plurality of mobile nodes. The method further includes sending the location transmission schedule for the plurality of mobile nodes.

### TECHNICAL FIELD

The present disclosure relates to a wireless communication network, and, in particular, to positioning measurement reporting for mobile radio network nodes of the wireless communication network.

### BACKGROUND

Wireless communication networks, such as cellular networks, enable various human- and machine-centric services, including providing positioning measurement reporting of user devices for various purposes. Future wireless communication networks will include mobile base stations and/or network access points (e.g., aerial base stations with adaptive altitudes, and/or base stations mounted on ground vehicles, as non-limiting examples) to provide radio connectivity. Such mobile radio network nodes can extend radio coverage to areas in which accessing mobile networks with fixed access points is difficult or impossible at present. Mobile radio network nodes are also relevant for locations and scenarios in which network access demand varies significantly over time (e.g., in a stadium, a shopping mall, a factory, an underground mine, a seaport, or a remote natural resource exploration and extraction site). Such mobile radio network nodes can also be useful to meet special quality of service (QoS) demands of users requiring accurate positioning and localization and/or users requiring communications that are highly secure, extremely reliable, and/or very high-speed.

The network of mobile radio network nodes can also include moving relays, which extend access to users that are difficult to reach otherwise in a cost-efficient way. Current wireless communication networks already provide relays, and enable links between relays in a manner similar to device-to-device (D2D) and vehicle-to-vehicle (V2V) sidelinks. Additionally, D2D and V2V positioning techniques and technologies are presently emerging.

Future networks will also provide connectivity to humans and devices aloft, such as drones and/or passengers in an airplane, as non-limiting examples. Positioning of such users is also important. To this end, the 3^{rd} Generation Partnership Project (3GPP) has approved a new study item on enhanced support for aerial vehicles in its Technical Specification Group (TSG) Radio Access Network (RAN) #75 plenary meeting. In terms of Long-Term Evolution (LTE) enhancements, positioning for aerial vehicles is one objective of the study item.

Small-cell solutions have traditionally targeted enhancing mobile network data rates in dense urban areas (mainly indoor locations such as stadiums, shopping malls, and the like) with high capacity demands. Motivated by operator obligations to reach 100% coverage in rural areas, another approach to the use of small cells has emerged. In this approach, mobile small cells (e.g., drones and/or balloons) are used, with drones being more suited to situations requiring fast deployment and limited subscribers, and balloons being employed in situations in which a slower deployment is acceptable, but a better deployment footprint is required.

Positioning in LTE is supported by the architecture illustrated in FIG. 1. As seen in FIG. 1, direct interactions between a user equipment (UE) 100 and a location server (i.e., an Evolved Serving Mobile Location Center, or E-SMLC) 102 are enabled via the LTE Positioning Protocol (LPP) (defined in 3GPP Technical Specification (TS) 36.355 [1]), as indicated by arrow 104. Moreover, there are also interactions between the E-SMLC 102 and an eNodeB (eNB) 106 via the LPPa protocol (defined in 3GPP TS 36.455 [2]), as indicated by arrow 108. The interactions between the E-SMLC 102 and the eNB 106 may be supported to some extent by interactions between the eNB 106 and the UE 100 using an LTE-Uu interface via the Radio Resource Control (RRC) protocol (defined by 3GPP TS 36.331 [3]), as indicated by arrow 110. Additionally, the E-SMLC 102 and mobility management entity (MME) 112 interact using an SLs interface via the Location Services Application (LCS-AP) protocol (defined in 3GPP TS 29.171 [4]), as indicated by arrow 114. Likewise, the MME 112 and a gateway mobile location center (GMLC) 116 interact using an SL_{g} interface (defined in 3GPP TS 29.172 [5]), as indicated by arrow 118.

In addition to the protocols and interfaces shown in FIG. 1, the following positioning techniques are considered in LTE, as described in 3GPP TS 36.305 [6]:
Enhanced Cell ID, which provides cell identifier (ID) information to associate a UE with a serving area of a serving cell, and also provides additional information to determine a finer granularity position;
Assisted Global Navigation Satellite System (GNSS), in which GNSS information is retrieved by a UE and supported by assistance information provided to the UE from an E-SMLC.
Observed Time Difference of Arrival (OTDOA), in which a UE estimates the time difference of reference signals from different base stations, and sends time difference data to an E-SMLC for multilateration; and
Uplink Time Difference of Arrival (UTDOA), in which a UE is requested to transmit a specific waveform that is detected by multiple location measurement units (e.g., an eNB) at known positions, which then forward the measurements to an E-SMLC for multilateration.

However, non-line-of-sight (NLOS) situations are known to present challenges in the context of wireless positioning. There are presently no commercial solutions available to address such challenges and still provide sufficiently precise positioning, particularly in view of the tight expected positioning requirements in 5G wireless communication networks. Additionally, in rural areas, one challenging issue for wireless communication network positioning is the sparse network deployment resulting in very large inter-site distance (ISD) between macro cells. While GNSS positioning may provide initial positioning functionality, GNSS receivers often are expensive in terms of cost and energy consumption. Further, the precision GNSS positioning provides may be too imprecise to manage platoons of drones or mobile base stations/access points. Where there are multiple drones in relatively close proximity, lack of precision may be problematic as it may make determining inter-drone positioning more challenging as the drones are maneuvered.

### SUMMARY

Embodiments of a method performed by a network node for determining a position of a mobile node are disclosed herein. In some embodiments, the method performed by a network node for determining a position of a mobile node comprises generating a location transmission schedule for a plurality of mobile nodes. The method further comprises sending the location transmission schedule for the plurality of mobile nodes. In this manner, location services are improved.

In some embodiments, the method further comprises receiving preliminary location information from the plurality of mobile nodes. In some embodiments, the preliminary location information comprises satellite-based location information.

In some embodiments, sending the location transmission schedule for the plurality of mobile nodes comprises sending the location transmission schedule to the plurality of mobile nodes. In some embodiments, the network node is one of a base station, a drone, an automobile, a train, or a handset, and sending the location transmission schedule comprises sending the location transmission schedule through an intermediate node to the plurality of mobile nodes. In some embodiments, the plurality of mobile nodes comprises at least one of a drone mobile node, an automobile mobile node, a handset mobile node, and a train mobile node.

In some embodiments, the method further comprises sending the location transmission schedule to a user equipment (UE). In some embodiments, the UE comprises a drone UE, an automobile UE, a handset UE, or a train UE. In some embodiments, at least one of the plurality of mobile nodes comprises a radio access node.

In some embodiments, the method further comprises receiving additional location information. In some embodiments, receiving additional location information comprises receiving the additional location information from at least one of the plurality of mobile nodes. In some embodiments, the method further comprises calculating a location of the at least one of the plurality of mobile nodes using the additional location information. In some embodiments, calculating the location comprises using a least squares method to calculate the location.

Embodiments of a network node for determining a position of a mobile node are also disclosed. In some embodiments, the network node is adapted to generate a location transmission schedule for a plurality of mobile nodes. The network node is further adapted to send the location transmission schedule for the plurality of mobile nodes. In some embodiments, the network node is further adapted to perform the method for determining a position of a mobile node disclosed herein.

Embodiments of a method performed by a mobile node for determining a position of another mobile node are also disclosed. In some embodiments, the method performed by the mobile node comprises receiving, at the mobile node, a location transmission schedule from a network node. The method further comprises performing measurements, at the mobile node, on signals from other nodes in accordance with the location transmission schedule.

In some embodiments, performing the measurements comprises performing TOA measurements on the signals. In some embodiments, the method further comprises, at the mobile node, calculating a position of the mobile node based on the measurements performed on the signals from the other nodes. In some embodiments, the other nodes comprise at least one other mobile node.

In some embodiments, the method further comprises sending the measurements performed on the signals from the other nodes to the network node. In some embodiments, the location transmissions schedule comprises a sequence of transmission for a plurality of mobile nodes including the mobile node.

Embodiments of a mobile node for determining a position of another mobile node configured to communicate with a UE are also disclosed. In some embodiments, the mobile node comprises a radio interface and processing circuitry. The mobile node is configured to receive a location transmission schedule from a network node. The mobile node is further configured to perform measurements on signals from other nodes in accordance with the location transmission schedule. In some embodiments, the mobile node is further configured to perform the method for determining a position of another mobile node disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram illustrating exemplary protocols and interfaces employed by Long Term Evolution (LTE) wireless communication networks for providing architectural support for positioning;

FIG. 2 illustrates one example of a cellular communication network according to some embodiments of the present disclosure;

FIG. 3 is a block diagram illustrating establishment of a multi-hop route between fixed base stations and a user equipment (UE) using multiple mobile radio network nodes;

FIG. 4 is a simplified system level diagram showing a plurality of mobile nodes interoperating with a satellite positioning system and terrestrial nodes for positioning determination;

FIG. 5 is a flowchart illustrating a process for positioning determination from a mobile node perspective;

FIG. 6A is a flowchart illustrating a process for positioning determination from a network node perspective where the network node performs positioning calculations;

FIG. 6B is a flowchart illustrating a process for positioning determination from a network node perspective where a mobile node performs positioning calculations;

FIG. 7 is a signal flow diagram showing nodes transmitting signals to be measured for positioning according to a transmission schedule;

FIG. 8 is a schematic block diagram of a network node, and particularly a network node acting as a radio access node according to some embodiments of the present disclosure;

FIG. 9 is a schematic block diagram that illustrates a virtualized embodiment of the network node of FIG. 8 according to some embodiments of the present disclosure;

FIG. 10 is a schematic block diagram of the network node of FIG. 8 according to some other embodiments of the present disclosure;

FIG. 11 is a schematic block diagram of a UE according to some embodiments of the present disclosure; and

FIG. 12 is a schematic block diagram of the UE of FIG. 11 according to some other embodiments of the present disclosure.

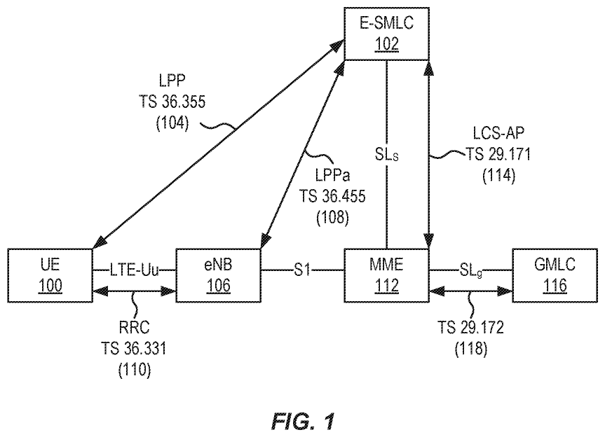

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communication network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Repository Function (NRF), a Policy Control Function (PCF), a Unified Data Management (UDM), or the like.

Wireless Device: As used herein, a “wireless device” is any type of device that has access to (i.e., is served by) a cellular communication network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communication network/system. In particular, a network node can be a radio access node and may be fixed or mobile.

Note that the description given herein focuses on a 3GPP cellular communication system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

Systems and methods for providing network-assisted inter-drone positioning are disclosed herein.

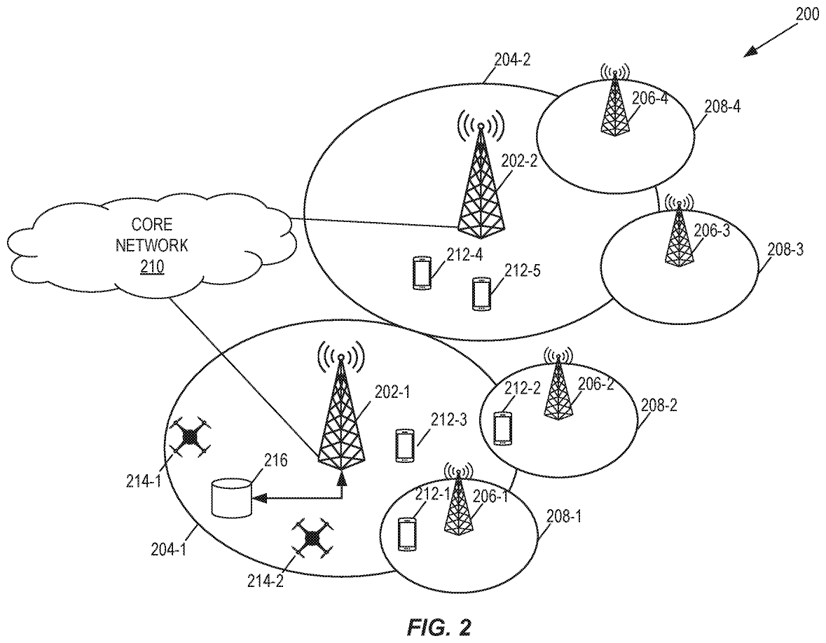

In this regard, FIG. 2 illustrates one example of a wireless communication network 200 (e.g., a cellular communication network) according to some embodiments of the present disclosure. In some embodiments, the wireless communication network 200 is an LTE network or a 5G NR network. In this example, the wireless communication network 200 includes base stations 202-1 and 202-2, which in LTE are referred to as eNBs and in 5G NR are referred to as gNBs, controlling corresponding macro cells 204-1 and 204-2. The base stations 202-1 and 202-2 are generally referred to herein collectively as base stations 202 and individually as base station 202. A base station 202 may be a radio access node and is likewise considered a network node. Likewise, the macro cells 204-1 and 204-2 are generally referred to herein collectively as macro cells 204 and individually as macro cell 204. The wireless communication network 200 may also include a number of low-power nodes 206-1 through 206-4 controlling corresponding small cells 208-1 through 208-4. The low-power nodes 206-1 through 206-4 can be small base stations or Remote Radio Heads, or the like. Notably, while not illustrated, one or more of the small cells 208-1 through 208-4 may alternatively be provided by the base stations 202. The low-power nodes 206-1 through 206-4 are generally referred to herein collectively as low-power nodes 206 and individually as low-power node 206. Likewise, the small cells 208-1 through 208-4 are generally referred to herein collectively as small cells 208 and individually as small cell 208. The base stations 202 are connected to a core network 210.

The base stations 202 and the low-power nodes 206 provide service to wireless devices 212-1 through 212-5 in the corresponding cells 204 and 208. As such the low-power nodes 206 may likewise be radio access nodes and are considered network nodes. The wireless devices 212-1 through 212-5 are generally referred to herein collectively as wireless devices 212 and individually as wireless device 212. The wireless devices 212 are also sometimes referred to herein as UEs. The base stations 202 may also be communicatively coupled to a location server (i.e., an Evolved Serving Mobile Location Center, or E-SMLC), such as the location server 216. The location server 216 is configured to collect positioning measurements and other location information from, e.g., the base stations 202, the wireless devices 212, and/or other devices within the wireless communication network 200, and assisting devices with positioning measurements and estimations.

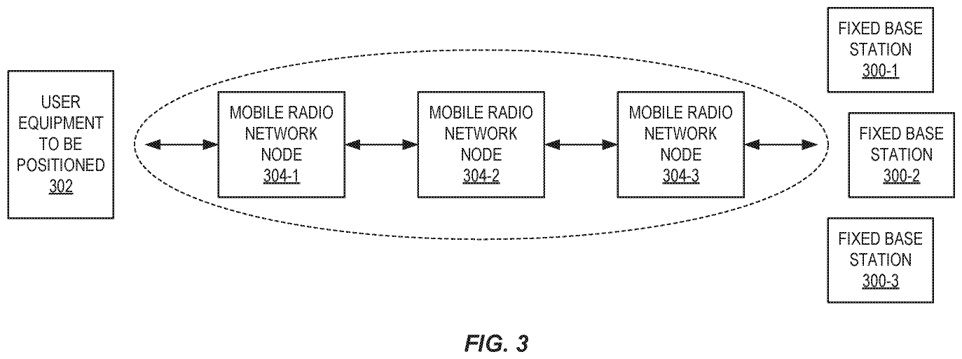

To address the challenges described above with respect to, e.g., non-line-of-sight (NLOS) scenarios and/or sparse network deployment with large inter-site distance (ISD) between macro cells, one or more mobile radio network nodes 214 (e.g., mobile radio network nodes 214-1 and 214-2, also sometimes referred to as simply a mobile node) are provided for positioning purposes. Each of the mobile radio network nodes 214 is equipped with a small cell and is connected via wireless backhaul to the wireless communication network 200 (e.g., via a macro cell, or via another of the mobile radio network nodes 214). The mobile radio network nodes 214 each provide a relay between base stations (e.g., the base stations 202) and mobile units (i.e., the wireless devices 212) for positioning purposes, and thus can provide mobile node positioning in spite of an NLOS link between mobile units and base stations. In some embodiments, multiple mobile radio network nodes 214 may connect to each other in sequence to create a chain of relays providing a multi-hop route between the base stations 202 and the wireless devices 212. Multi-hop routes and factors affecting their establishment and positioning measurements are discussed in greater detail below with respect to FIG. 3. Note further that in some instances, the mobile radio network nodes 214 may be a UE and not have relay or small cell functionality.

The use of a set of mobile radio network nodes 214 acting as mobile network access points and/or moving relays enables the degree of freedom in their mobility to be used to accurately determine a position of a particular user or group of users of the wireless devices 212 and/or a position of other moving access points and relays. For example, a multi-hop connection can be established between moving access points and relays, taking into account positioning requirements of users, relays, and access points, their sensing and measuring capabilities, and other quality of service (QoS) requirements that may exist. An illustration is shown in FIG. 3, which illustrates establishment of a multi-hop route between fixed base stations 300 and a UE 302 using multiple mobile radio network nodes 304 (e.g., the mobile radio network nodes 214 of FIG. 2, as non-limiting examples).

The accuracy of radio-based positioning techniques (e.g., based on time of arrival and angle of arrival of radio signals) relies heavily on the reception of sufficiently strong line-of-sight (LOS) signals at the receiving device or node. Consequently, positioning accuracy may be significantly degraded in the absence of LOS signal reception. This is different from other QoS requirements, where absence of LOS is often not a major issue because several reflected signals, when combined properly, can enhance performance.

Therefore, a multi-hop route, such as that illustrated in FIG. 3, that is established with positioning requirements in mind may be very different from a multi-hop route that is established to satisfy other QoS requirements for communication. The criteria for establishing (and dynamically re-establishing) a multi-hop route between mobile radio network nodes may include consideration of the following:
Required positioning accuracy of the mobile radio network nodes to be positioned;
Radio propagation conditions (e.g., achieving LOS signal receptions between mobile radio network nodes);
Sensing capabilities of mobile radio network nodes (e.g., provision of different sensors and their measurement performance, wherein the sensors can be of various types such as sensors for vision, radio signal reception, inertial, magnetic field measurement, and/or air pressure measurement, and the like);
Radio signal transmission and reception capabilities (e.g., transceivers equipped with different antenna capabilities for transmission and/or reception);
Availability of anchor points in the environment (e.g., signatures placed in the environment to support highly accurate positioning of some mobile radio network nodes in the multi-hop route, through sensors such as cameras);
Constraints associated with mobility of mobile radio network nodes, given that some mobile radio network nodes have higher flexibility (e.g., flying mobile radio network nodes in air);
Network geometry (e.g., geometric dilution of precision for trilateration-based techniques like the Observed Time Difference of Arrival (OTDOA) positioning method employed in LTE);
Diversity and density of mobile radio network nodes to be positioned;
Availability of reliable power source to mobile radio network nodes (e.g., battery life and battery recharge capability using techniques such as energy harvesting); and
Other QoS requirements.

Once a multi-hop route is established, positioning measurements can be reported to the wireless communication network in various ways. Selection of an appropriate measurement reporting protocol can depend on factors such as the following:
Which mobile radio network nodes in the network accurately know their own position;
Whether a positioning request is initiated by the wireless communication network, by the mobile radio network node to be positioned, or by an external entity;
Whether a multi-hop route can be reconfigured before measurement reporting is complete (which would require checking that reporting is done even if route is reconfigured); and
Any positioning requirements that impact granularity of the measurement report and reliability of the reporting protocol.

Exemplary aspects of the present disclosure focus on knowing the positions of the mobile nodes with sufficient precision such that the mobile radio network nodes accurately know their own absolute position as well as their position relative to other mobile nodes to assist in maneuvering the mobile nodes as well as to assist in location services for a UE. In exemplary aspects, the positions of the mobile nodes are determined with the assistance of other mobile nodes (which may be small cells, relays, or one or more UEs), UEs, and/or fixed nodes. To facilitate such location determination, exemplary aspects of the present disclosure allow mobile nodes in line of sight to each other to engage in schedule-based transmissions which are used to help calculate absolute as well as relative positions. The network may provide different control information for configuring the mobile nodes for relative positioning and keep a list of active mobile nodes. The list is updated as mobile nodes enter and exit line of sight of one another. Further, the schedule of transmissions is updated as needed to reflect such entry and exit from line of sight of one another.

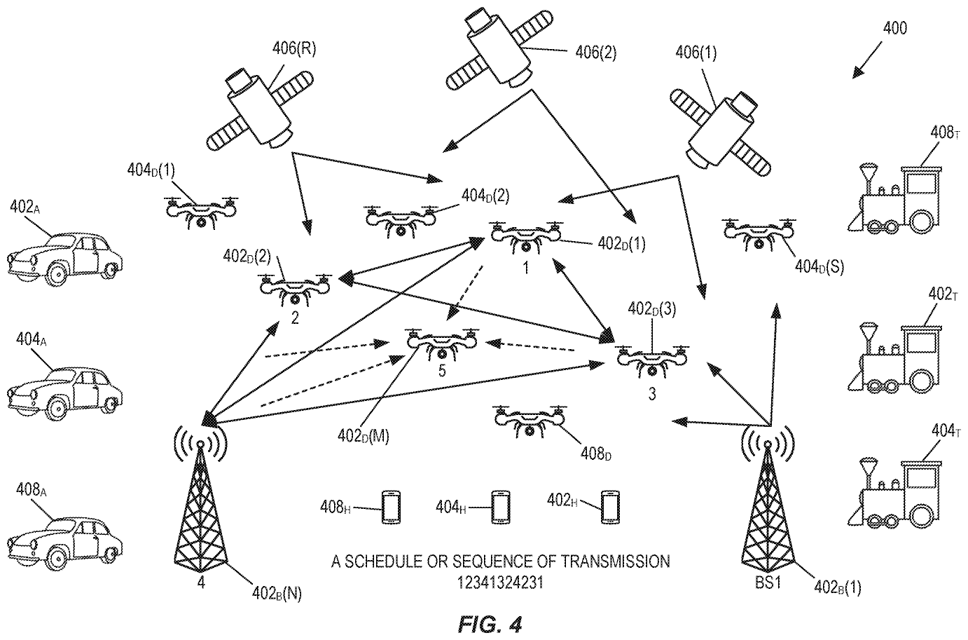

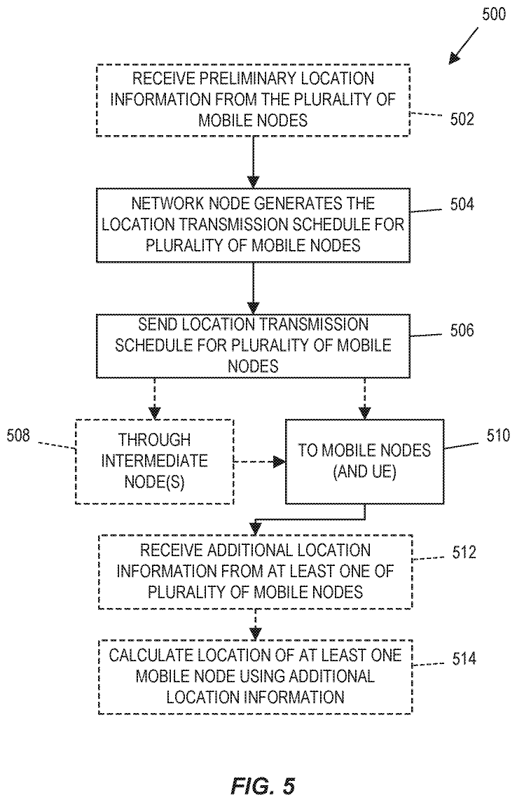

Exemplary aspects of the present disclosure provide great flexibility in the types of and functionalities provided by mobile nodes. Accordingly, an overview of the cellular network that may implement the present disclosure is provided in FIG. 4, with the processes of the present disclosure discussed below beginning with reference to FIG. 5.

In this regard, FIG. 4 illustrates a network 400 that includes one or more network nodes including fixed base station network nodes 402_{B}(1)-402_{B}(N), an automobile network node 402_{A}, a train network node 402_{T}, drone network nodes 402_{D}(1)-402_{D}(M), and a handset network node 402_{H}. Collectively, the network nodes are referred to as network nodes 402. While only one automobile network node 402_{A}, train network node 402_{T}, and handset network node 402_{H} are illustrated, it should be appreciated that there may be more than one of each of these types of network nodes. It should be appreciated that the network nodes 402 may act as radio access nodes. Some or all of these network nodes may also be mobile nodes such as an automobile mobile node 404_{A}, a train mobile node 404_{T}, drone mobile nodes 404_{D}(1)-404_{D}(S), and a handset mobile node 404_{H}. Collectively, these are referred to as mobile nodes 404. While only one automobile mobile node 404_{A}, train mobile node 404_{T}, and handset mobile node 404_{H} are illustrated, it should be appreciated that there may be more than one of each of these types of mobile nodes. It should be appreciated that the mobile nodes 404 may act as radio access nodes. Alternatively, trains, automobiles, drones, and handsets may just be a UE, such as an automobile UE 408_{A}, a train UE 408_{T}, a drone UE 408_{D}, and a handset UE 408_{H}. While only one automobile UE 408_{A}, train UE 408_{T}, drone UE 408_{D}, and handset UE 408_{H} are illustrated, it should be appreciated that there may be more than one of each of these types of UE. Collectively, these are referred to as UE 408.

Satellites 406(1)-406(R) may provide satellite-based position information to any of the network nodes 402, mobile nodes 404, and UE 408. The satellites 406(1)-406(R) may belong to a satellite constellation designed to provide location information such as a global positioning system (GPS) or Global Navigation Satellite System (GNSS). As explained in greater detail below, a network node 402 such as network node 402_{B}(1) may track which mobile nodes 404 are proximate one another (e.g., within line of sight) by an identifier assigned by the network 400, device identifier, serial number, or the like, and generate a location transmission schedule that dictates an order in which nodes 402, 404 on the list transmit to assist in location determination.

Exemplary aspects of the present disclosure provide great flexibility in using the various elements of network 400. In particular, the location transmission schedule may be generated at any of the network nodes 402 including the mobile nodes 404. The transmissions used to calculate positions may be generated by any of the network nodes 402, mobile nodes 404, or UE 408 depending on availability and relative positions. Likewise, calculations on measured transmissions may occur at any of the network nodes 402, mobile nodes 404, or a remotely positioned location server (e.g., location server 216 of FIG. 2). With the understanding that there is a point of diminishing returns and with the understanding that more calculations may add latency, the more transmissions used to calculate relative positions, the more precisely the relative locations of the various mobile nodes 404 may be determined.

Use of the location transmission schedule allows for better inter-mobile-node positioning which is useful for drone maneuvering so as to facilitate collaboration between autonomous drones and to facilitate swarming of drones. Exemplary aspects further provide for low latency in positioning updates with greater accuracy while also allowing an acceptable compromise between centralized network control on positioning and distributed mobile node-based measurements. The ability to modify the location transmission schedule allows great flexibility. While the present disclosure is particularly well suited for use with drones being the mobile nodes 404, it should be appreciated that other mobile nodes 404 such as those identified above may also be used and benefit from the present disclosure. The present disclosure is readily scalable to accommodate differing numbers of mobile nodes 404, with greater precision being available as more mobile nodes 404 are used. Likewise, the present disclosure is flexible enough to accommodate different types of drones or mobile nodes 404 including those that may be receiving only (e.g., due to power constraints).

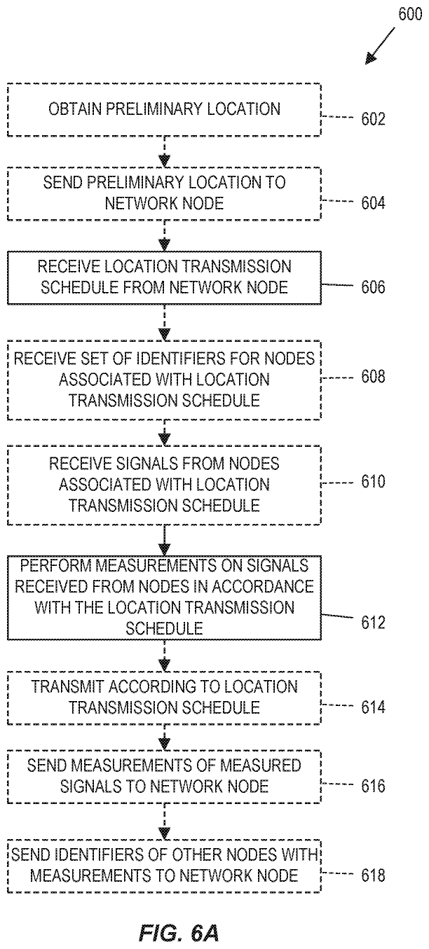

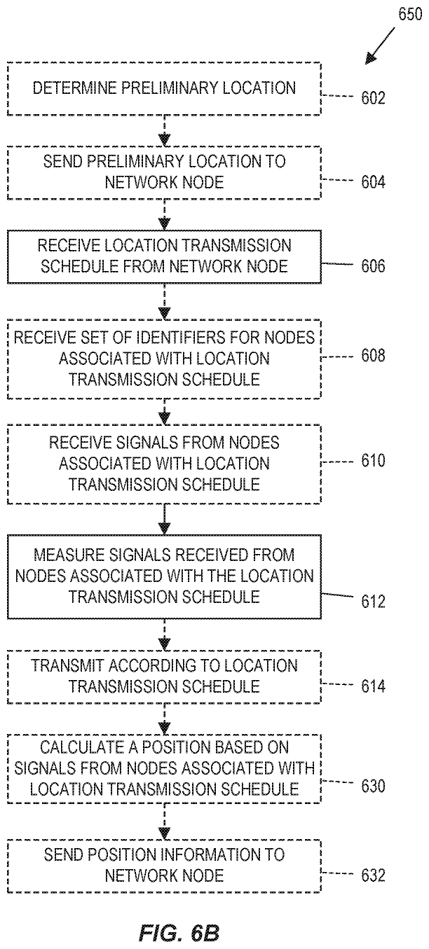

The processes associated with the present disclosure are set forth with reference to FIGS. 5-6B, with FIG. 5 being a process 500 that occurs at a network node 402 such as the base station network node 402_{B}(1). While it is expected that a fixed network node such as the base station network node 402_{B}(1) performs the process 500, the present disclosure is not so limited, and the process 500 may occur in other network nodes 402 including mobile nodes 404. Likewise, FIGS. 6A and 6B illustrate processes 600 and 650, respectively, that may take place at a mobile node 404 such as drone mobile node 404_{D}(1), but parts of the processes 600 and 650 may occur in UE 408.

In this regard, FIG. 5 illustrates the process 500 that begins with the network node 402 receiving preliminary location information from a plurality of mobile nodes 404 (block 502). Optionally, the network node 402 may also receive location information from one or more UE 408 as well. This location information may include a node identifier (e.g., a serial number, a device identifier assigned by the network 400, or other identifier) as well as preliminary location information such as may have been provided to the mobile nodes 404 by a satellite system (e.g., satellites 406) or general location server (e.g., location server 216) within the network 400. This step is optional, but does assist in refining the position of a mobile node to an accuracy that is not present in traditional commercial GNSS type satellite positioning systems.

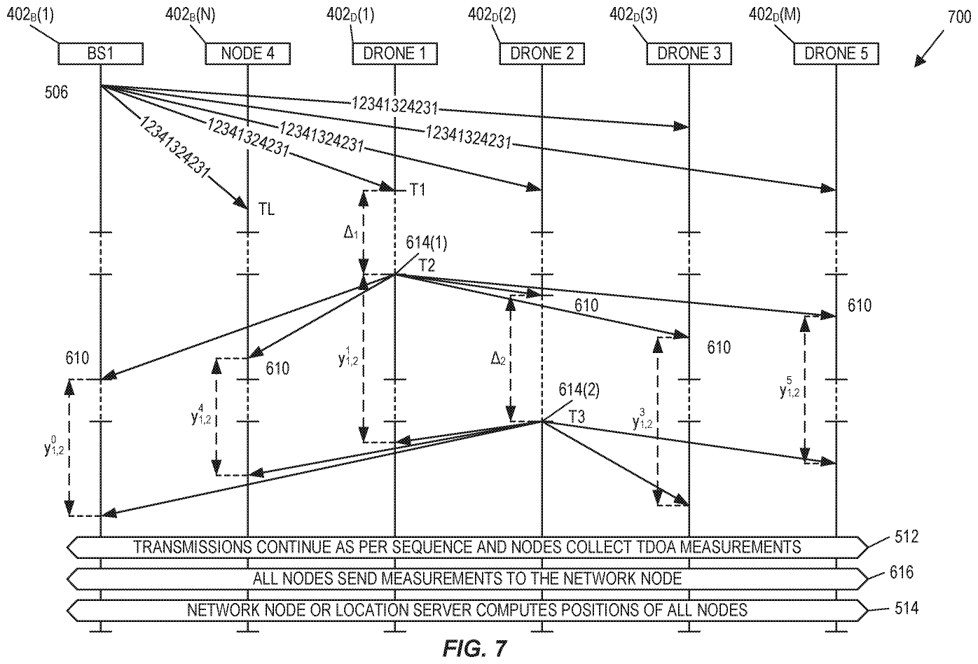

The network node 402 then generates a location transmission schedule for the plurality of mobile nodes 404 (and optionally the UE 408 and/or any relevant fixed nodes (e.g., base station network node 402_{B}(N)) (block 504). This location transmission schedule indicates in what order and at what times each of the mobile nodes 404, network nodes 402, and/or UE 408 transmit a signal. That is, the location transmission schedule includes identifiers for all the network nodes 402, mobile nodes 404, and/or UE 408 in the vicinity of the area of interest and defines a sequence in which the identified nodes and/or UE are to transmit according to predefined timing information. More details are provided on how the location transmission schedule works below with reference to FIG. 7.

As illustrated in FIGS. 4 and 7, this location transmission schedule may be similar to 12341324231 or the like. Note further that the location transmission schedule may be sent to one or more low-power nodes that may not be able to transmit because of power constraints or the like. As illustrated in FIG. 4, and the example location transmission schedule, the drone network node 402_{D}(M) (e.g., node 5) is considered to be one such low-power node.

Having generated the location transmission schedule, the network node 402 sends the location transmission schedule for the plurality of mobile nodes 404 (block 506). Again, the location transmission schedule may also be sent to any fixed network nodes (e.g., network node 402_{B}(N) or UE 408 if present). In an optional exemplary aspect, the location transmission schedule is sent through intermediate nodes (block 508) such as relays 304 or the like. Alternatively, the network node 402 may send the location transmission schedule directly to the mobile nodes 404 (block 510) (and/or other network nodes 402 and/or UE 408).

The mobile nodes 404 (and/or the UE 408 and/or any designated network nodes 402) transmit signals including their respective identifiers to each other, to network nodes 402, and to any UE 408 in accordance with the location transmission schedule. The receivers of these signals perform measurements on these signals and transmit information derived from these signals. Thus, the network node 402 may then receive additional location information from at least one of the plurality of mobile nodes 404 (block 512) and may receive such additional location information from other network nodes 402 and/or UE 408. As explained in greater detail below, in a first exemplary aspect, the mobile nodes 404 perform calculations based on the received messages to determine a respective location, and the additional location information is that calculated location. In a second exemplary aspect, the mobile nodes 404 pass the measured signals with identifiers to the network node 402, and the network node 402 (or the location server 216) calculates the location of at least one mobile node 404 using the additional location information (block 514). Thus, in an exemplary aspect, the signals may include an identifier of the source of the signal as well as a time of arrival (TOA) measurement of the signal received by each detected mobile node 404 or network node 402. In a further exemplary aspect, a UE 408 (or mobile node 404 or network node 402) performs at least two TOA measurements based on signals from two different transmitters (e.g., the transmitters of other mobile nodes 404, other network nodes 402, UE 408, or the like), and from those TOA measurements, the UE 408 (or mobile node 404 or network node 402) may calculate a time difference of arrival (TDOA) measurement. This calculated TDOA measurement may then be transmitted such that some other entity (e.g., a network node 402, another mobile node 404, the location server 216, or the like) within the network 400 may perform position determination calculations. The signals to the network node 402 may further include an indication that a given element (mobile node 404, UE 408, or network node 402) has contributed to the location transmission procedure and has sent its respective signal at the scheduled time in accordance with the location transmission schedule.

As still another alternative, the mobile nodes 404 may do some calculations or signal conditioning short of the final calculations and send this intermediate information to the network node 402 for final calculations. It should be appreciated that the present disclosure provides great flexibility for where within the network 400 position determination is performed.

FIGS. 6A and 6B illustrate processes 600 and 650, respectively, that correspond to alternate processes for elements responding to the location transmission schedule (e.g., a mobile node 404, a network node 402, or UE 408). For ease of illustration, it is assumed that this element is a mobile node 404 such as a drone mobile node 404_{D}. In this regard, the process 600 begins with the drone mobile node 404_{D} obtaining a preliminary location (block 602). In an exemplary aspect, this preliminary location is derived from a satellite positioning system such as GPS or GNSS from satellites 406(1)-406(R). Alternatively this preliminary location may be provided from the network 400 such as from a location server 216 (FIG. 2), through schedule-based positioning or the like. It is generally accepted that this preliminary location is not exceptionally precise and is optional. The drone mobile node 404_{D} may, if the preliminary location is available, send the preliminary location to the network node 402_{B}(1) (block 604). If the network node 402_{B}(1) has access to the preliminary location from a different source (e.g., the location server 216), this step may be omitted. Even if there is no alternate source, this step is optional, but does improve the accuracy of later calculations.

The drone mobile node 404_{D} receives the location transmission schedule from the network node 402_{B}(1) (block 606). As noted above, the location transmission schedule may include identifiers for each of the elements in the location transmission schedule and thus, the drone mobile node 404_{D} may optionally receive the set of identifiers for nodes (e.g., network nodes 402, mobile nodes 404, and/or UE 408) associated with the location transmission schedule (block 608). The drone mobile node 404_{D} may further receive signals from nodes associated with the location transmission schedule (block 610).

The drone mobile node 404_{D} then performs measurements on signals received from the other nodes in accordance with the location transmission schedule (block 612). These measurements may be TOA or TDOA (or both with the TDOA based on TOA measurements) or the like as explained in greater detail below. The drone mobile node 404_{D} may also transmit a signal on which other nodes perform TOA measurements according to the location transmission schedule (block 614). This signal may include at least an identifier of what node initiated the transmission, but may also include a time of transmission, any preliminary location information, or any other information as desired. Note that the drone mobile node 404_{D} may not transmit, for example, if the drone mobile node 404_{D} is operating under a power constraint. In an exemplary aspect, the network node 402_{B}(1) that created the location transmission schedule is aware of any such constraints and has generated or modified the location transmission schedule accordingly.

The drone mobile node 404_{D} may send measurements of the measured signals to the network node 402_{B}(1) (block 616) and may further send identifiers of other nodes from whom the measurements were made to the network node 402_{B}(1) (block 618) so that the network node 402_{B}(1) or the location server 216 may calculate relative positions.

The process 650 of FIG. 6B is similar to the process 600 of FIG. 6A, with many of the initial steps the same. However, instead of sending measurements to the network node 402_{B}(1), the drone mobile node 404_{D} may calculate a position based on the signals from nodes associated with the location transmission schedule (block 630) and send this position information to the network node 402_{B}(1) (block 632).

FIG. 7 provides a signal flow 700 of the transmission of the location transmission schedule to a variety of nodes and the subsequent transmission and reception in accordance with the location transmission schedule, assuming that the position calculations are done in the network rather than by the mobile nodes. In this example, there are five nodes contributing to the internode positioning. Specifically, network node 402_{B}(1) acts to generate the location transmission schedule and transmits the location transmission schedule (e.g., 12341324231) (block 506, FIG. 5) to network node 402_{B}(N) (node 4), drone network nodes 402_{D}(1)-402_{D}(3) (nodes 1-3) and power constrained drone network node 402_{D}(M) (node 5). For the purposes of this example, the drone network nodes 402_{D} are within line of sight of each other. The drone network nodes 402_{D}(1)-402_{D}(3) do not have power constraints and are freely able to transmit and receive signals. In contrast, for this example, the drone network node 402_{D}(M) has some power constraint and only operates in a receive mode. The network node 402_{B}(1) receives the preliminary location information and identifies the set of nodes that are within line of sight of one another. The network node 402_{B}(1) uses this set of nodes that are within line of sight of one another to generate the location transmission schedule. In addition to the preliminary location information, the location transmission schedule may also be based on a total number of available nodes, any estimation of accuracy of the preliminary location information, any preference on precision to any specific node, power consumption requirements of the nodes (e.g., nodes with stringent power requirements may be scheduled less or not all), and any participation of any network node in schedule-based positioning. Still other considerations may be a requirement to provide a certain quality of estimation about a position of a specific mobile node 404 or a requirement to serve a specific geographic region. Note that this set of nodes does not need to be in line of sight of the network node 402_{B}(1), just within line of sight of each other. In this example, the location transmission schedule is 12341324231 with timing constraints associated therewith.

This location transmission schedule is communicated to the set of nodes that are within line of sight of one another either directly or through appropriate relays (noted generally at 506 in FIG. 7 corresponding to block 506 of process 500). Alternatively, the location transmission schedule may be communicated to a single node, which then forwards the location transmission schedule to the other nodes in the set. Note that the arrival of the location transmission schedule may not be synchronized (e.g., drone network node 402_{D}(3) receives the location transmission schedule before the network node 402_{B}(N)). For the sake of the example, the location transmission schedule arrives at the first node to transmit in accordance with the schedule at time T1.

Continuing the example in FIG. 7, at some time T2 (T2=T1+Δ₁), the first node in the location transmission schedule transmits a signal (noted at 614(1)). Note that T2 is later than the time required for the last node of the location transmission schedule to receive the location transmission schedule (denoted TL in FIG. 7). The receiving nodes perform TOA measurements on these signals (generally noted for example at 610 in FIG. 7, corresponding to block 610 of FIG. 6). At some time T3 (T3=T2+time of propagation from node 1 to node 2+Δ₂), the second node in the location transmission schedule transmits a signal (noted at 614(2)). The receiving nodes again perform TOA measurements on the received signals. From these two TOA measurements, each of the nodes in the location transmission schedule may measure or calculate a TDOA, denoted Y_{i,j}^{k}, which denotes the TDOA of the signal from the node i and the signal from node j at node k. The transmissions continue through the location transmission schedule, with the receiving nodes performing TOA measurements on the signals as they arrive and measuring or calculating additional TDOA values (denoted in FIG. 7 as arrow 512, corresponding to block 512 of the process 500). At some point, perhaps periodically, perhaps at the end of the location transmission schedule, or at designated points within the location transmission schedule, the set of nodes within the location transmission schedule send any collected measured signals to the network node 402_{B}(1) for processing as noted at arrow 616 of FIG. 7, corresponding to block 616 of the process 600. These measurements are either processed by the network node 402_{B}(1) or at a location server 216 (denoted by arrow 514 of FIG. 7, corresponding to block 514 of the process 500).

Note that the drone network node 402_{D}(M) may also receive the signals and may do its own calculations to improve its position without transmitting to the other nodes. Note also, that even without the preliminary location information, the relative positions of the mobile nodes 404 can be estimated by all the mobile nodes 404 for proximity detection to avoid collisions or the like.

In an exemplary aspect, the location server 216 may estimate the position of the mobile nodes 404 from the measurements received using a least square problem.

$$\hat{x} = arg {min}_{x} {‖ y - h ( x ) ‖}^{2}$$

Where the vector \hat{x} is the N×3 matrix of positions of all mobile nodes 404 in the network. The vector y is the vector of the TDOA measurements available at the location server 216. h(x) is the function vector which is a function of the locations of the mobile nodes 404 positions and the location transmission schedule.

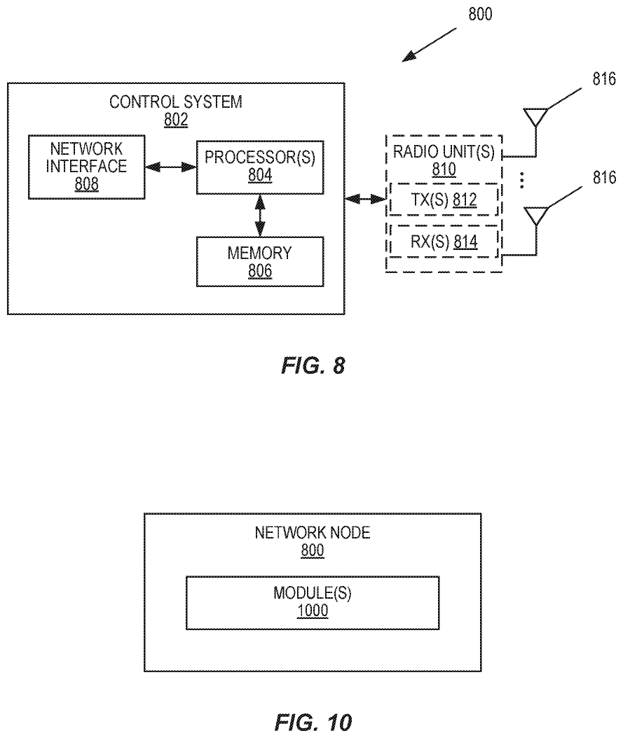

FIG. 8 is a schematic block diagram of a network node 800 that acts as a radio access node according to some embodiments of the present disclosure. The network node 800 may be, for example, a base station 202, 206, or any of the network nodes 402. As illustrated, the network node 800 includes a control system 802 that includes one or more processors 804 (Application Specific Integrated Circuits, Field Programmable Gate Arrays, and/or the like), memory 806, and a network interface 808. The one or more processors 804 are also referred to herein as processing circuitry. In addition, the network node 800 includes one or more radio units 810 that each include one or more transmitters 812 and one or more receivers 814 coupled to one or more antennas 816. The radio units 810 may be referred to as, or be part of, radio interface circuitry. In some embodiments, the radio unit(s) 810 is external to the control system 802 and connected to the control system 802 via, e.g., a wired connection. However, in some other embodiments, the radio unit(s) 810 and potentially the antenna(s) 816 are integrated together with the control system 802. The one or more processors 804 operate to provide one or more functions of a network node 800 as described herein. In some embodiments, the function(s) are implemented in software that is stored, e.g., in the memory 806 and executed by the one or more processors 804.

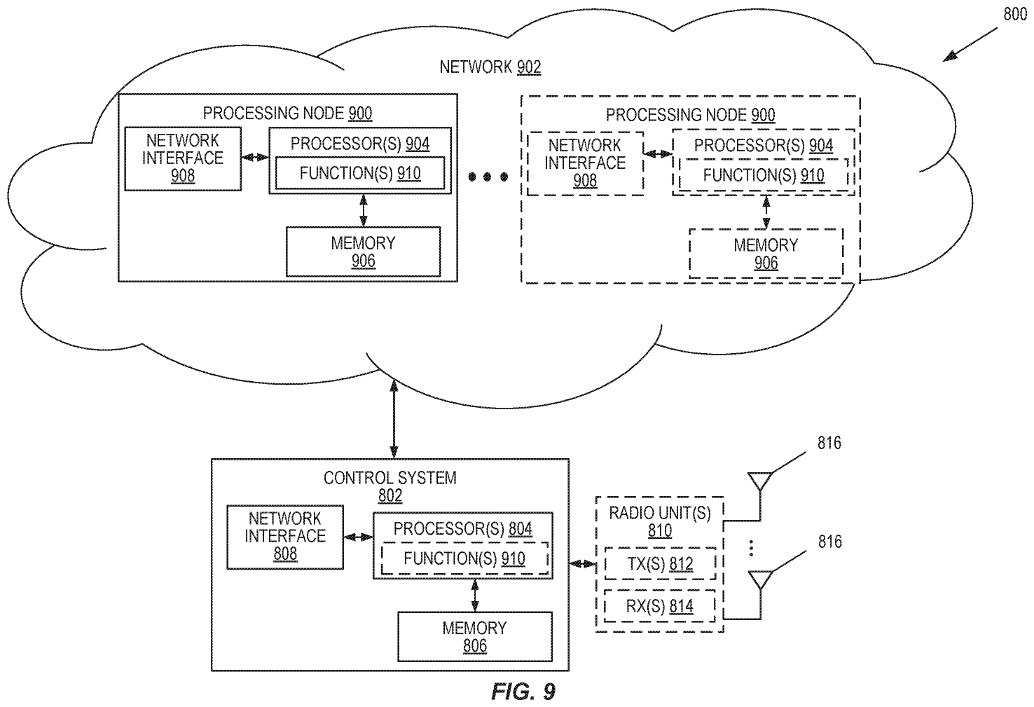

FIG. 9 is a schematic block diagram that illustrates a virtualized embodiment of the network node 800 according to some embodiments of the present disclosure. This discussion is equally applicable to other types of network nodes. Further, other types of network nodes may have similar virtualized architectures.

As used herein, a “virtualized” network node is an implementation of the network node 800 in which at least a portion of the functionality of the network node 800 is implemented as a virtual component(s) executing on a physical processing node(s) in a network(s). As illustrated, in this example, the network node 800 includes the control system 802 that includes the one or more processors 804, the memory 806, and the network interface 808, and the one or more radio units 810 that each includes the one or more transmitters 812 and the one or more receivers 814 coupled to the one or more antennas 816, as described above. The control system 802 is connected to the radio unit(s) 810 via, for example, an optical cable or the like. The control system 802 is connected to one or more processing nodes 900 coupled to or included as part of a network(s) 902 via a network interface 908. Each processing node 900 includes one or more processors 904, memory 906, and a network interface 908.

In this example, functions 910 of the network node 800 described herein are implemented at the one or more processing nodes 900 or distributed across the control system 802 and the one or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, cause the at least one processor to carry out the functionality of the network node 800 or a node implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a non-transitory computer readable storage medium.

FIG. 10 is a schematic block diagram of the network node 800 according to some other embodiments of the present disclosure. The network node 800 includes one or more module(s) 1000, each of which is implemented in software. The module(s) 1000 provide the functionality of the network node 800 described herein. This discussion is equally applicable to the processing node(s) 900 of FIG. 9 where the module(s) 1000 may be implemented at one of the processing nodes 900 or distributed across multiple processing node(s) 900 and/or distributed across the processing node(s) 900 and the control system 802.

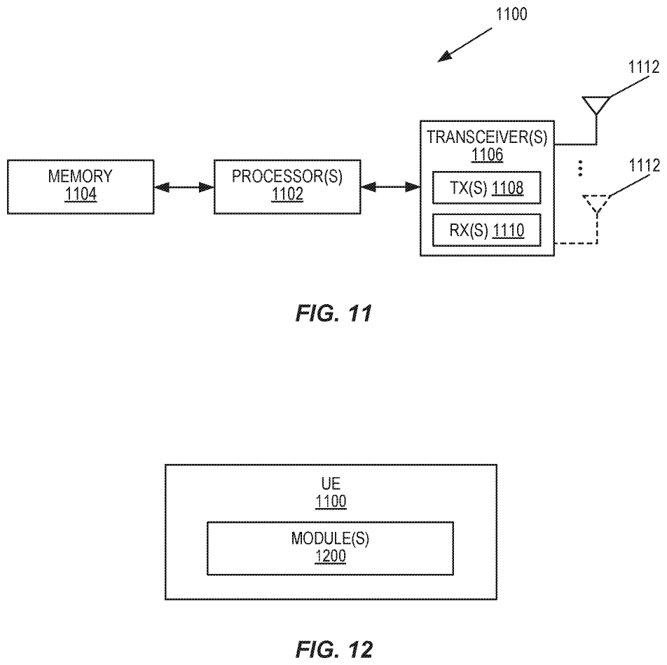

FIG. 11 is a schematic block diagram of a UE 1100 according to some embodiments of the present disclosure. The UE 1100 may be any of the UE 408. As illustrated, the UE 1100 includes one or more processors 1102, memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by one of ordinary skill in the art. The one or more processors 1102 are also referred to herein as processing circuitry. The transceivers 1106 are also referred to herein as radio circuitry. In some embodiments, the functionality of the UE 1100 described above may be fully or partially implemented in software that is, e.g., stored in the memory 1104 and executed by the processor(s) 1102. Note that the UE 1100 may include additional components not illustrated in FIG. 11 such as, e.g., one or more user interface components, and/or the like and/or any other components for allowing input of information into the UE 1100 and/or allowing output of information from the UE 1100, a power supply, etc.

In some embodiments, a computer program including instructions which, when executed by at least one processor, causes the at least one processor to carry out the functionality of the UE 1100 according to any of the embodiments described herein is provided. In some embodiments, a carrier comprising the aforementioned computer program product is provided. The carrier is one of an electronic signal, an optical signal, a radio signal, or a computer readable storage medium.

FIG. 12 is a schematic block diagram of the UE 1100 according to some other embodiments of the present disclosure. The UE 1100 includes one or more module(s) 1200, each of which is implemented in software. The module(s) 1200 provide the functionality of the UE 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
AP Access Point
ASIC Application Specific Integrated Circuit
BSC Base Station Controller
BTS Base Transceiver Station
CD Compact Disk
COTS Commercial Off-the-Shelf
CPE Customer Premise Equipment
CPU Central Processing Unit
D2D Device-to-Device
DAS Distributed Antenna System
DSP Digital Signal Processor
DVD Digital Video Disk
eNB Enhanced or Evolved Node B
E-SMLC Evolved Serving Mobile Location Center
FPGA Field Programmable Gate Array
GHz Gigahertz
gNB New Radio Base Station
GSM Global System for Mobile Communications
IoT Internet of Things
IP Internet Protocol
LEE Laptop Embedded Equipment
LME Laptop Mounted Equipment
LTE Long Term Evolution
M2M Machine-to-Machine
MANO Management and Orchestration
MCE Multi-Cell/Multicast Coordination Entity
MDT Minimization of Drive Tests
MIMO Multiple Input Multiple Output
MME Mobility Management Entity
MSC Mobile Switching Center
MSR Multi-Standard Radio
MTC Machine Type Communication
NB-IoT Narrowband Internet of Things
NFV Network Function Virtualization
NIC Network Interface Controller
NR New Radio
O&M Operation and Maintenance
OSS Operations Support System
OTT Over-the-Top
PDA Personal Digital Assistant
P-GW Packet Data Network Gateway
RAM Random Access Memory
RAN Radio Access Network
RAT Radio Access Technology
RF Radio Frequency
RNC Radio Network Controller
ROM Read Only Memory
RRH Remote Radio Head
RRU Remote Radio Unit
SCEF Service Capability Exposure Function
SOC System on a Chip
SON Self-Organizing Network
UE User Equipment
USB Universal Serial Bus
V2I Vehicle-to-Infrastructure
V2V Vehicle-to-Vehicle
V2X Vehicle-to-Everything
VMM Virtual Machine Monitor
VNE Virtual Network Element
VNF Virtual Network Function
VoIP Voice over Internet Protocol
WCDMA Wideband Code Division Multiple Access
WiMax Worldwide Interoperability for Microwave Access

Those skilled in the art will recognize improvements and modifications to the embodiments of the present disclosure. All such improvements and modifications are considered within the scope of the concepts disclosed herein.

1. A method performed by a network node for determining a position of a mobile node, the method comprising:
generating a location transmission schedule for a plurality of mobile nodes; and
sending the location transmission schedule for the plurality of mobile nodes.

2. The method of claim 1, further comprising receiving preliminary location information from the plurality of mobile nodes.

3. The method of claim 2, wherein the preliminary location information comprises satellite-based location information.

4. The method of claim 1, wherein sending the location transmission schedule for the plurality of mobile nodes comprises sending the location transmission schedule to the plurality of mobile nodes.

5. The method of claim 1, wherein the network node is one of a base station, a drone, an automobile, a train, and a handset, and sending the location transmission schedule comprises sending the location transmission schedule through an intermediate node to the plurality of mobile nodes.

6. The method of claim 1, wherein the plurality of mobile nodes comprises at least one of: a drone mobile node, an automobile mobile node, a handset mobile node, and a train mobile node.

7. The method of claim 1, further comprising sending the location transmission schedule to a user equipment, UE.

8. The method of claim 7, wherein the UE comprises one of a drone UE, an automobile UE, a handset UE, and a train UE.

9. The method of claim 1, wherein at least one of the plurality of mobile nodes comprises a radio access node.

10. The method of claim 1 further comprising receiving additional location information.

11. The method of claim 10, wherein receiving additional location information comprises receiving the additional location information from at least one of the plurality of mobile nodes.

12. The method of claim 10, further comprising calculating a location of the at least one of the plurality of mobile nodes using the additional location information.

13. The method of claim 12, wherein calculating the location comprises using a least squares method to calculate the location.

14. A network node for determining a position of a mobile node, the network node configured to:
generate a location transmission schedule for a plurality of mobile nodes; and
send the location transmission schedule for the plurality of mobile nodes.

15. (canceled)

16. A method performed by a mobile node for determining a position of another mobile node, comprising:
receiving, at the mobile node, a location transmission schedule from a network node; and
performing measurements, at the mobile node, on signals from other nodes in accordance with the location transmission schedule.

17. The method of claim 16, wherein performing the measurements comprises performing time of arrival, TOA, measurements on the signals.

18. The method of claim 16, further comprising, at the mobile node, calculating a position of the mobile node based on the measurements performed on the signals from the other nodes.

19. The method of claim 16, wherein the other nodes comprise at least one other mobile node.

20. (canceled)

21. The method of claim 16, wherein the location transmission schedule comprises a sequence of transmission for a plurality of mobile nodes including the mobile node.

22. A mobile node for determining a position of another mobile node, the mobile node configured to communicate with a user equipment, UE, the mobile node comprising a radio interface and processing circuitry configured to:
receive a location transmission schedule from a network node; and
perform measurements on signals from other nodes in accordance with the location transmission schedule.

23. (canceled)
